(19) United States
(12) Patent Application Publication
(10) Pub. No.: US 2008/0231615 A1
(43) Pub. Date: Sep. 25, 2008

(54) INPUT DEVICE

(75) Inventors: Tsuyoshi Tanaka, Kyoto (JP); Hitokazu Shitanaka, Fukui (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 12/026,615

(22) Filed: Feb. 6, 2008

(30) Foreign Application Priority Data
Mar. 22, 2007 (JP) 2007-074184

(51) Int. Cl. G05G 1/02

(52) U.S. Cl. 345/184

(57) ABSTRACT

Disclosed here is an input device used for input operations of electronic equipment. According to the input device, an illuminating display section is disposed on an operation knob, and the controller of the device effects on/off control of the illuminating display section in connection with showing indications on the display of the device. With the structure above, the on/off state of the illuminating display section allows a user to easily confirm the current operating status of the electronic equipment, without looking at indications shown in the display.

### FIELD OF THE INVENTION

The present invention relates to an input device mainly used for operations of an air conditioner or an audio system mounted on a car.

### BACKGROUND ART

In recent years, car manufacturers have been introducing various advanced cars on the market. In such a car, a multifunction-equipped input device is disposed on the front panel section in the interior of the car, by which the driver easily operates electronic equipment, such as an air conditioner and an audio system.

FIG. 3 is a circuit block diagram of a conventional input device. Insulating resin-made operation knobs 1 and 2 are formed into a disk-shape. Housing 3 is also made of insulating resin and formed into a box-shape. Operation knob 1 is disposed on the front right and operation knob 2 is disposed on the front left of housing 3, both of which are rotatable and depressible. The top face of operation knob 1 has indication section 1A on which an indication is provided by printing or the like.

Two electronic components 4 are rotatable and depressible, one of which is attached to operation knob 1 and the other is attached to operation knob 2. Electronic components 4 are formed of a switch, a variable resistor or the like. Each of electronic components 4 has insulating resin-made case 4A and operation shaft 4B protruding forward. Case 4 accommodates switch contacts and a resistor circuit (not shown). Each of operation knobs 1 and 2 is attached to operation shaft 4B. Rotating and depressing operations of operation knobs 1 and 2 allow the switch contacts to carry out electrical switching operations and change the resistance value.

Housing 3 accommodates a wiring board (not shown) that has a plurality of wiring patterns on the top and bottom surfaces. Two electronic components 4 are electrically connected to the wiring patterns on the wiring board by soldering. Similarly, other electronic components including a fixed resistor and a connector (not shown) are mounted on the wiring board.

Display 6, which is a liquid crystal display (LCD) panel or the like, is attached to housing 3 with the display section exposed at the front of housing 3. In addition, controller 7, which is a microcomputer or the like, is mounted on the wiring board. Electronic components 4 and display 6 are electrically connected to controller 7.

Such structured input device is mounted on the front panel section in a manner that operation knob 1 is positioned on the side of the driver's seat and operation knob 2 is positioned on the side of the passenger's seat. Controller 7 is electrically connected, via a connector and a lead wire (not shown), to electronic equipment 8 as a driven object, such as an air conditioner, an audio system and an electronic circuit of the car.

FIGS. 4A through 4C are front views of a conventional input device. The drawings show an example where electronic equipment 8 (hereinafter, simply equipment 8) is an air conditioner and the temperature is set at 27° C. In this case, at engine starting, display 6 shows “27° C.” as a predetermined temperature on the left and the right sides.

The driver presses operation knob 1 with an indication of “PUSH AUTO” thereon to put the air conditioner into an automatic operation mode in terms of the quantity of air and a direction of airflow. The pressing force allows the switch contacts disposed behind operation knob 1 to carry out electrical switching operations. Detecting an electrical signal generated in the switching operations, controller 7 puts equipment 8 into the automatic operation mode; at the same time, requests display 6 to show an indication of “AUTO”—representing that equipment 8 runs in the automatic operation mode—in the upper right of the display, as shown in FIG. 4B.

For example, to change a predetermined setting of temperature, the driver rotates operation knob 1. The rotation of operation knob 1 allows the switch contacts disposed behind operation knob 1 to carry out electrical switching operations and change the resistance value. Detecting an electrical signal generated in the switching operations, controller 7 changes the setting of temperature of equipment 8 and requests display 6 to show a newly set temperature (e.g. 32° C.), as shown in FIG. 4C.

The operations above can be carried out with the use of operation knob 2 by a fellow passenger in the passenger's seat. The rotation of operation knob 2 allows switch contacts disposed behind operation knob 2 to carry out electrical switching operations. Through the operation on rotation knob 2, the temperature setting and the indication of the set value shown in the passenger's side changes to a newly set value. That is, the operation mode and the temperature setting of the air conditioner can be individually determined by the driver (with the use of operation knob 1) and the fellow passenger (with the use of operation knob 2). Controller 7 judges which knob has been operated by detecting the electrical switching from electronic components 4 on the left or the right side, and requests display 6 to show an indication corresponding to the operation. In this way, display 6 shows the current operating status set by the driver or the fellow passenger.

FIG. 5 is a detailed front view of a conventional input device. In addition to a setting value of temperature and the indication of “AUTO”, display 6 shows various indications, such as the quantity of air, the direction of airflow and ventilating condition.

As a prior-art reference relating to the present application, Japanese Patent Unexamined Publication No. 2005-216798 is known.

However, the indication of “PUSH AUTO” on indication section 1A of operation knob 1 is indelibly marked by printing or the like. Therefore, even after the mode of equipment 8 has been changed into the automatic operation mode and “AUTO” appears in the upper right on display 6, “PUSH AUTO” on indication section 1A stays there; the driver cannot recognize the current operation mode by the indication on indication section 1A. That is, the driver cannot confirm the current operation mode of the air-conditioner before finding the indication of “AUTO” among various indications on display 6. According to the conventional input device, as described above, the driver has to have selective confirmation from various indications on display 6 to know the current operating status of equipment 8 including an air-conditioner or an audio system. This has often involved a complicated operation and accordingly an operation error.

### SUMMARY OF THE INVENTION

The present invention addresses the problem above. It is therefore the object of the present invention to provide a user-friendly, easy-to-see input device.

According to the input device, an operation knob has an illuminating display section. In response to the operations of the rotatable and depressible electronic component, the controller effects on/off control of the illuminating display section in connection with showing indications on the display. For example, the controller shows an indication according to a certain operation by the driver or the person in the passenger's seat; at the same time, turns on/off the illuminating display section on the operation knob. The on/off state of the illuminating display section allows the driver to confirm the current operating status without looking at the display. The structure provides a user-friendly, easy-to-see input device.

### BRIEF DESCRIPTION OF THE DRAWINGS

FIG. 1 is a circuit block diagram of an input device in accordance with an exemplary embodiment of the present invention.

FIG. 2A is a front view of the input device in accordance with the exemplary embodiment.

FIG. 2B is another front view of the input device in accordance with the exemplary embodiment.

FIG. 2C is still another front view of the input device in accordance with the exemplary embodiment.

FIG. 2D is yet another front view of the input device in accordance with the exemplary embodiment.

FIG. 3 is a circuit block diagram of a conventional input device.

FIG. 4A is a front view of the conventional input device.

FIG. 4B is another front view of the conventional input device.

FIG. 4C is still another front view of the conventional input device.

FIG. 5 is a detailed front view of the conventional input device.

### DETAILED DESCRIPTION OF THE INVENTION

### Exemplary Embodiment

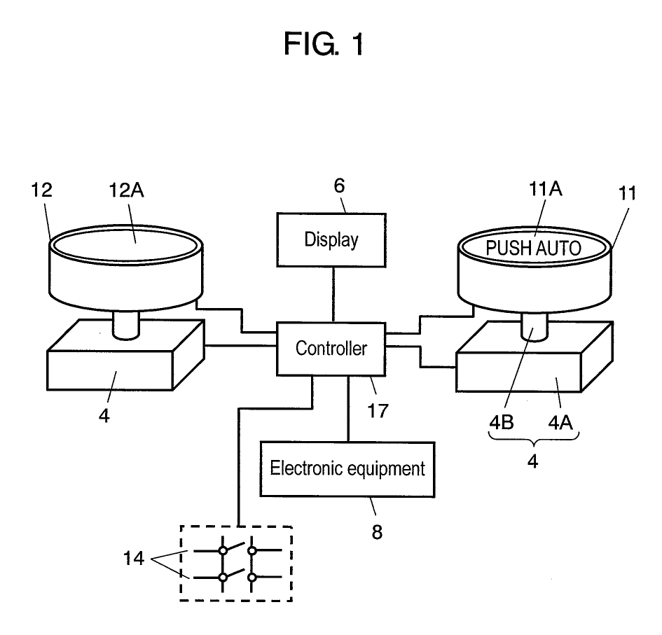

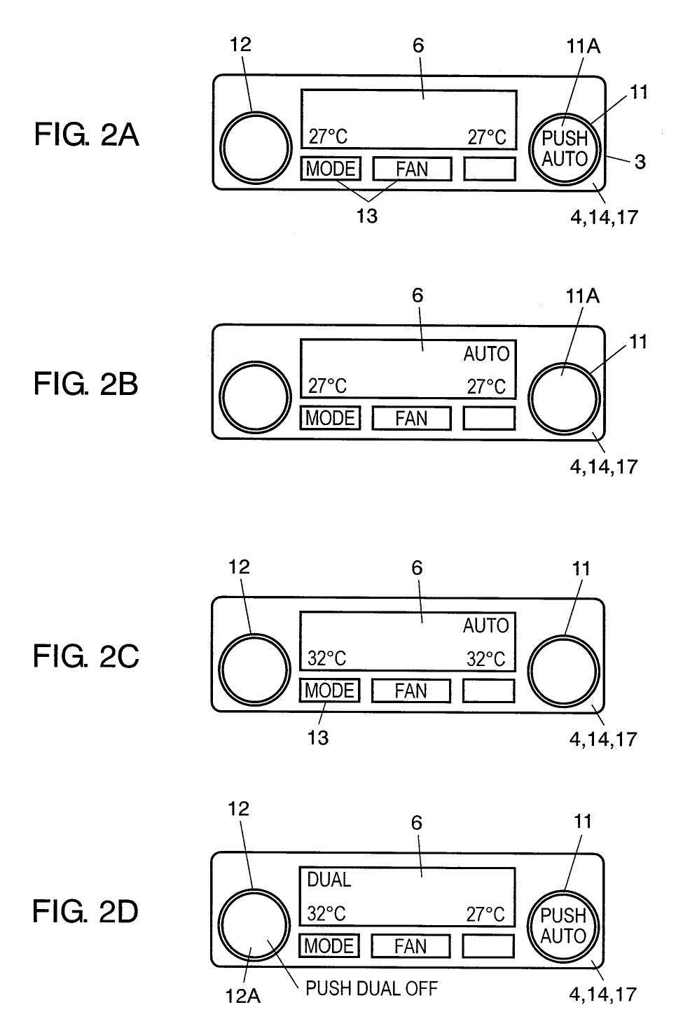

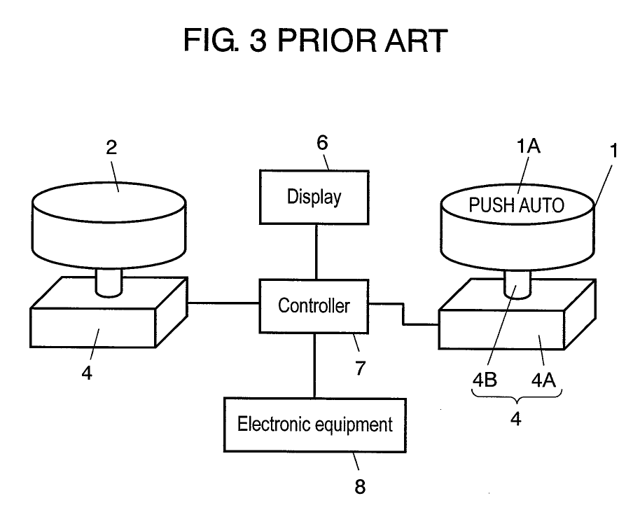

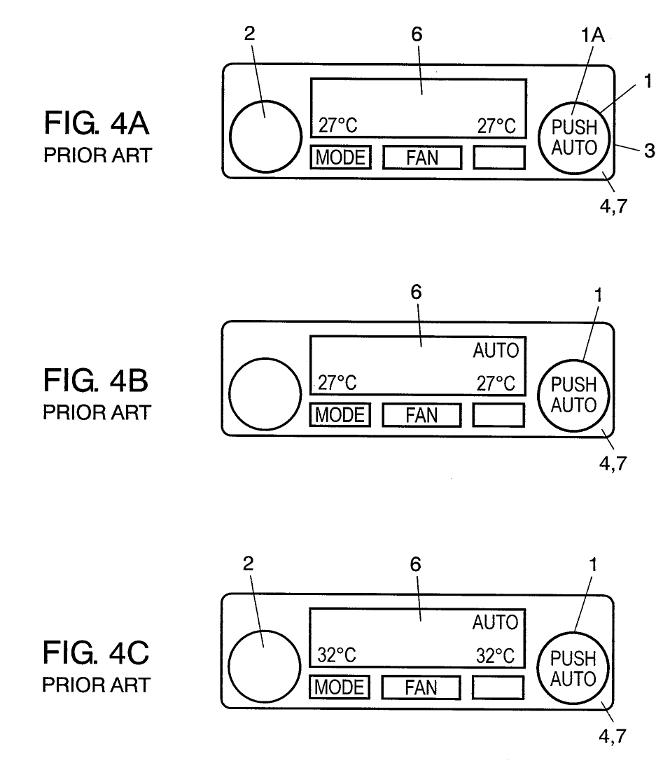

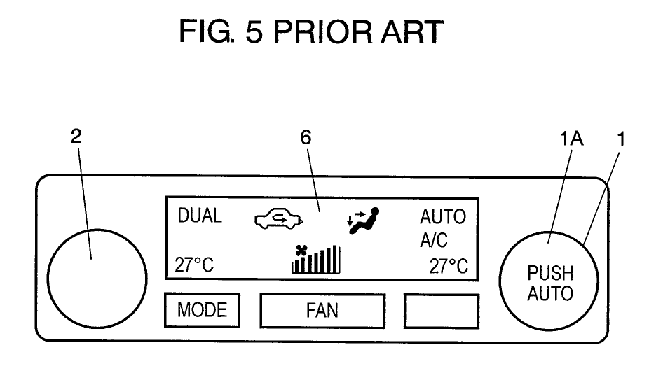

FIG. 1 is a circuit block diagram of an input device in accordance with the exemplary embodiment of the present invention. FIGS. 2A through 2D are front views of the input device in accordance with the exemplary embodiment of the present invention. Operation knobs 11 and 12 shown in FIGS. 1 and 2 are made of insulating resin, such as acrylic and polycarbonate, and are formed into a disk-shape. Housing 3 is also made of insulating resin and is formed into a box-shape. Operation knob 11 is disposed on the front right and operation knob 12 is disposed on the front left of housing 3 so as to be rotatable and depressible. Operation knobs 11 and 12 have illuminating display sections 11A and 12A, respectively, for showing indications (including letters and symbols) on each top face.

Electronic components 4, which are rotatable and depressible, are formed of a switch, a variable resistor or the like. Each of electronic components 4 has insulating resin-made case 4A and operation shaft 4B protruding forward. Case 4A accommodates switch contacts and a resistor circuit (not shown). Each of operation knobs 11 and 12 is attached to operation shaft 4B. Rotating and depressing operations of operation knobs 11 and 12 allow the switch contacts to carry out electrical switching operations and change the resistance value.

Housing 3 accommodates a wiring board (not shown) that has a plurality of wiring patterns on the top and bottom surfaces. Two electronic components 4 are electrically connected to the wiring patterns formed on the wiring board by soldering. Similarly, other electronic components including a fixed resistor and a connector (not shown) are mounted on the wiring board.

Display 6, which is a liquid crystal display (LCD) panel or the like, is positioned at the center of housing 3 with the display section exposed at the front of housing 3. A plurality of push buttons 13, which is made of insulating resin, is arranged under the display section. On the back side of push buttons 13, a plurality of switch contacts 14, such as a push switch, is disposed. In response to depressing force on push buttons 13, switch contacts 14 carry out electrical switching operations. Controller 17, which is a microcomputer or the like, is mounted on the wiring board in housing 3. Two electronic components 4, display 6, switch contacts 14, illuminating display sections 11A and 12A are connected to controller 17 via the wiring patterns.

Each of illuminating display sections 11A and 12A has i) an indication plate (not shown) having a translucent portion of characters, symbols, figures and ii) a translucent dark-colored (for example, black or brown) smoky plate (not shown). The indication plate and the translucent smoky plate are disposed in front of a light-emitting element (not shown), such as a light emitting diode, which is mounted adjacent to electronic components 4 on the wiring board. In the structure of the present invention, illuminating display sections 11A and 12A may be formed, by laser machining, double molding or the like, on the top face of operation knobs 11 and 12, respectively (, where each operation knob is made of an opaque material colored in black or brown). Each illuminating display section has dark-colored translucent indications formed of characters, symbols and figures. Light emitting elements, which are mounted on the wiring board and connected to controller 17, illuminate the illuminating display sections from behind. When the light emitting elements turn off, the indications in the illuminating display sections become inconspicuous.

Such structured input device is mounted on the front panel section in a manner that operation knob 11 is positioned on the side of the driver's seat and operation knob 12 is positioned on the side of the passenger's seat. Controller 17 is electrically connected, via a connector and a lead wire (not shown), to electronic equipment 8 as a driven object, such as an air conditioner, an audio system and an electronic circuit of the car.

FIG. 2A shows an example where equipment 8 is an air conditioner and the temperature is set at 27° C. In this case, at engine starting, display 6 shows “27° C.” as a predetermined temperature on the left and the right sides; at the same time, the indication of “PUSH AUTO” disposed on the top face of illuminating display section 11A of operation knob 11 stays illuminated.

The driver presses operation knob 11 to put the air conditioner into an automatic operation mode in terms of quantity of air and a direction of airflow. The pressing force allows the switch contacts disposed behind operation knob 11 to carry out electrical switching operations. Detecting an electrical signal generated in the switching operations, controller 17 puts equipment 8 into the automatic operation mode. Controller also requests display 6 to show “AUTO”—representing that equipment 8 runs in the automatic operation mode—in the upper right of the display, as shown in FIG. 2B. Furthermore, in response to the application of the pressing force to operation knob 11, controller 17 turns off the light emitting elements disposed behind operation knob 11, so that the indication on illuminating display section 11A becomes inconspicuous.

For example, to change a predetermined setting of temperature, the driver rotates operation knob 11. The rotation of operation knob 11 allows the switch contacts disposed behind operation knob 11 to carry out electrical switching operations and change the resistance value. Detecting an electrical signal generated in the switching operations, controller 17 changes the setting of temperature of equipment 8 and requests display 6 to show a newly set temperature (e.g. 32° C.), as shown in FIG. 2C.

To put the air conditioner into a manual mode in terms of setting of temperature, the quantity of air or the like, the driver operates one of push buttons 13 with an indication of “MODE” disposed below display 6. The pressing force allows switch contacts 14 disposed behind push button 13 to carry out electrical switching operations. Detecting an electrical signal generated in the switching operations, controller 17 switches the mode of equipment 8 from the automatic operation mode to the manual operation mode. Controller 17 also requests display 6 to erase the indication of “AUTO”, and turns on the light emitting element to illuminate the indication of “PUSH AUTO” on illuminating display section 11A.

The operations above can be carried out with the use of operation knob 12 by a fellow passenger in the passenger's seat. The rotation of operation knob 12 allows the switch contacts disposed behind operation knob 12 to carry out electrical switching operations. Detecting an electrical signal generated in the switching operations, controller 17 changes the setting of temperature and the indication of newly set value on the side of the passenger's seat, as shown in FIG. 2D. Controller 17 also requests display 6 to show the indication of “DUAL” in the upper left of the display. Furthermore, in response to the rotation of operation knob 12, controller 17 turns on the light emitting elements disposed behind operation knob 12, so that the indication of “PUSH DUAL OFF” stays illuminated on illuminating display section 12A. In this way, the operation mode and the temperature setting of the air conditioner can be determined, according to individual preference, by the driver (with the use of operation knob 11) and the fellow passenger (with the use of operation knob 12).

As is described above, the rotating or pressing force applied to operation knobs 11, 12 and push buttons 13 allow switch contacts 14 disposed behind them to carry out electrical switching operations. Detecting an electrical signal generated in the switching operations, controller 17 requests display 6 to show an indication according to the signal; at the same time, controller 17 turns on/off illuminating display sections 11A and 12A according to the operations. The structure above allows the driver and the fellow passenger to easily confirm the current operating status of the air conditioner and setting operations done by themselves, thereby providing user-friendly input device without operation error.

FIG. 2B shows the state where the input device of the present invention runs in the automatic operation mode; the indication of “AUTO” appears on display 6, while the indication of “PUSH AUTO” disappears from illuminating display section 11A since operation knobs 11, 12 turn off.

On the other hand, FIG. 2A shows the state where the air conditioner runs in the manual operation mode; the indication of “AUTO” now disappears from display 6, while the indication of “PUSH AUTO” comes back since illuminating display section 11A turns on.

FIG. 2D shows the state where the fellow passenger operates operation knob 12 to change the setting value of temperature on the passenger's side; the indication of “DUAL” appears on display 6 and at the same time, the indication of “PUSH DUAL OFF” is illuminated on illuminating display section 12A. That is, controller 17 detects the operations on operation knobs 11, 12 and push buttons 13 through electronic components 4 and the electrical switching operations of switch contacts 14. According to the operations above, controller effects on/off control of illuminating display sections 11A, 12A in connection with showing indications on display 6.

That is, confirming the on/off state of illuminating display sections 11A, 12A, the driver can easily know-without looking at display 6-the current condition of the air conditioner: operating in the automatic mode or the manual mode; having same or different setting value of temperature between the driver's side and the passenger's side. The structure above provides the driver with easy and simple input operations.

According to the structure of the present invention, as described above, illuminating display sections 11A and 12A are disposed on operation knobs 11 and 12, respectively. In response to the operations of electronic components 4, controller 17 effects on/off control of illuminating display sections 11A, 12A in connection with showing indications on display 6. For example, in response to operations carried out by the driver (or the fellow passenger), controller 17 determines the indication to be shown on display 6; at the same time, determines illuminating display sections 11A, 12A to be turned on or turned off. The on/off state of the illuminating display section allows the driver to quickly confirm the current operating status of the air conditioner without looking at display 6. Such structured input device provides simple and easy operations.

The description above introduces an example where the input device is employed for operating an air conditioner. It will be understood that the input device is also effective when it is employed for operating an audio system including a compact disc player and radio.

The input device of the present invention offers simple and easy input operations. It is therefore suitable for operations of an air conditioner and an audio system mounted on a car.

What is claimed is:

1. An input device comprising:
an operation knob having an illuminating display section;
a rotatable and depressible electronic component to which the operation knob is attached;
a controller; and
a display,
wherein, the controller is connected to the rotatable and depressible electronic component and the display, and the controller effects on/off control of the illuminating display section in connection with showing indications on the display according to operations on the rotatable and depressible electronic component.
